(19) United States
(12) Patent Application Publication
(10) Pub. No.: US 2008/0301800 A1
(43) Pub. Date: Dec. 4, 2008

(54) System and method for creating a virtual private network using multi-layered permissions-based access control

(76) Inventor: Sal KHAN, Greely (CA)

Correspondence Address: J. GORDON THOMSON, P.O. BOX 8865, VICTORIA, BC, V8V 3Z1, CA

(21) Appl. No.: 11/855,372

(22) Filed: Sep. 14, 2007

(30) Foreign Application Priority Data
May 29, 2007 (CA) 2590387

(51) Int. Cl. G06F 21/20

(52) U.S. Cl. 726/15

(57) ABSTRACT

A system and method for creating a virtual private network (VPN) over a computer network using multi-layered permissions-based access control comprises a first individual seeking to send a live message from a transmitting node to a second individual at a receiving node over a computer network; means for identifying persons authorized access to said computer network; a Network Guardian Server for authenticating the identity of said transmitting and receiving nodes; and, a System Guardian Server for authenticating the identity of said first and second individuals as persons authorized access to the computer network.

### FIELD OF THE INVENTION

The present invention relates to a system and method for secure communications over a network of computers and more specifically a system and method for creating a virtual private network using multi-layered permissions-based access control.

### BACKGROUND OF THE INVENTION

Data travelling on a local area network (LAN), or between two separated LANs, over a public network of computers such as the Internet can be protected by the creation of a virtual private network (VPN). Compact digital video cameras and other biometric scanning devices such as finger print recognition and voice recognition can be used with biometrics for individual authentication. Smartcards, tokens, personal identification numbers (PIN), standard encryption, Public Key Infrastructure (PKI), and embedded identification numbers (ID) can be used to authenticate the camera and or biometric scanning device. These can be incorporated into a VPN to create secure communications or data exchanges across a public system of computers.

### SUMMARY OF THE INVENTION

The invention comprises a system and method for creating a virtual private network (VPN) using multi-layered permissions-based access control. In one embodiment of the invention, the system comprises a first individual seeking to send a live message from a transmitting node to a second individual or a data storage server at a receiving node. In another embodiment of the system, the first individual may seek to access secure data in a remote database. All persons authorized to access the system are identified in an enrolment process by a system administrator. The enrolment process includes obtaining a biometric from each person having authorized access. The biometric is preferably a facial, finger, iris, or a voice biometric. Each node comprises a suitable biometric scanning device such as a camera connected to a processor, a smart-card reader, a token reader and a memory device connected to a computer also having a processor and a memory device. Establishment of the VPN includes authentication of the biometric device, authentication of the transmitting and receiving nodes and authentication of the first and second individuals (as necessary) where communication is to take place between two individuals. Biometric scanning device authentication relies upon the optional use of a personal identification number (PIN) and the use of a public key issued to each person seeking authorized access. The PIN is something the user knows and must be typed in on a keypad or computer keyboard. Alternatively, the user may speak his or her name into a microphone and the PIN will be submitted as soon as the voice metric is identified as authentic. The public key may be stored on a smart-card or token issued to each person seeking authorized access. A private key may stored on the biometric scanning device having a memory or it may be stored on the System Guardian or the Network Guardian installed on the system. When the individual seeking access inputs the PIN into the computer by way of a keyboard it is compared to the PIN on any one or all, of the biometric scanning device, System Guardian or Network Guardian for a match. As well, the public key is compared to the private key. If both match, then the biometric scanning device, smartcard, and or token are authenticated and access is given to the transmitting computer.

The system includes a local System Guardian server and a hosted Network Guardian server. The local System Guardian may be located within a corporation or home. The Network Guardian may be located at a secure hosting facility such as one provided by an Internet Service Provider. Both the local System Guardian server and the hosted Network Guardian server contain a processor and a memory. The memory on the System Guardian server stores the biometric templates of all persons authorized to have access to the secure system and addresses of all local users, biometric scanning devices and computers on the local system. The memory on the Network Guardian server stores the addresses of all users, biometric scanning devices and computers on all connected local systems. When the individual seeking to obtain remote access to a System Guardian or to send a message to a system user whose address is known to the Network Guardian, inputs the address where remote access is requested or inputs the recipient's e-mail address, the Network Guardian will ensure that the transmitting node address and receiving node address are both authorized addresses. If they are not, then access to the recipient will be denied.

Once the receiving and transmitting nodes are authenticated, then the identity of the person seeking remote access or sending a message is authenticated. The Network and System Guardian verify the identity of the biometric scanning device, and a smart card, token, or PIN (if any or all are required by the System Guardian's human administrator). The biometric scanning device obtains a biometric from the individual and this is compared to the biometrics of authorized persons stored on the System Guardian server. If there is a match then remote access is granted or the message is allowed to be transmitted to the receiving node. At the receiving node, the person receiving the message must also be authenticated biometrically using the process described above. The camera at the receiving node scans the recipient biometric and compares that biometric against the biometrics of authorized persons stored on the second computer also using one or all of a smartcard, token or PIN. Once the recipient is authorized, the VPN is established and data can be accessed from the remote location or a live communication session can commence.

### OBJECTIVES OF THE INVENTION

It is an objective of the present invention to provide a system and method for providing secure remote access to a local network by creating a VPN having strong multi-factor authentication for secure, encrypted text, image, voice and video transmissions.

### BRIEF DESCRIPTION OF DRAWINGS

The present invention will be further understood from the following description with references to the drawings in which:

FIG. 1 is a schematic diagram of multi-factor identity authentication used to access a secure computer network.

FIG. 1A is a diagram of a typical biometric scanning device in this case a camera and workstation having a smart-card reader.

FIG. 2 shows the spatial relationship between an individual seeking access to the system and the workstation during facial biometric scanning.

FIG. 3 is a schematic diagram of a workstation comprising a biometric scanning device namely a camera connected to a computer having access to the communications network.

FIG. 3A is a schematic diagram of the biometric scanning device namely a camera and computer combination connected to a server through a firewall.

FIG. 3B is a schematic diagram of the biometric scanning device namely a camera and computer showing the system guardian.

FIG. 4 is a schematic diagram of the system administrator and the enrolment of persons authorized access to the system.

FIG. 4A is a schematic diagram of one embodiment of the invention where a digital biometric scanning device identification serial number is used to confirm camera identity.

FIG. 5 is a schematic diagram showing the smart-card concept associated with one embodiment of the present invention.

FIG. 6 is a schematic diagram of the operation of one embodiment of the invention.

FIG. 7 is a schematic diagram showing the authentication of the message recipient.

FIG. 8 is a schematic diagram showing creation of the VPN for access to a remote data repository.

### DETAILED DESCRIPTION

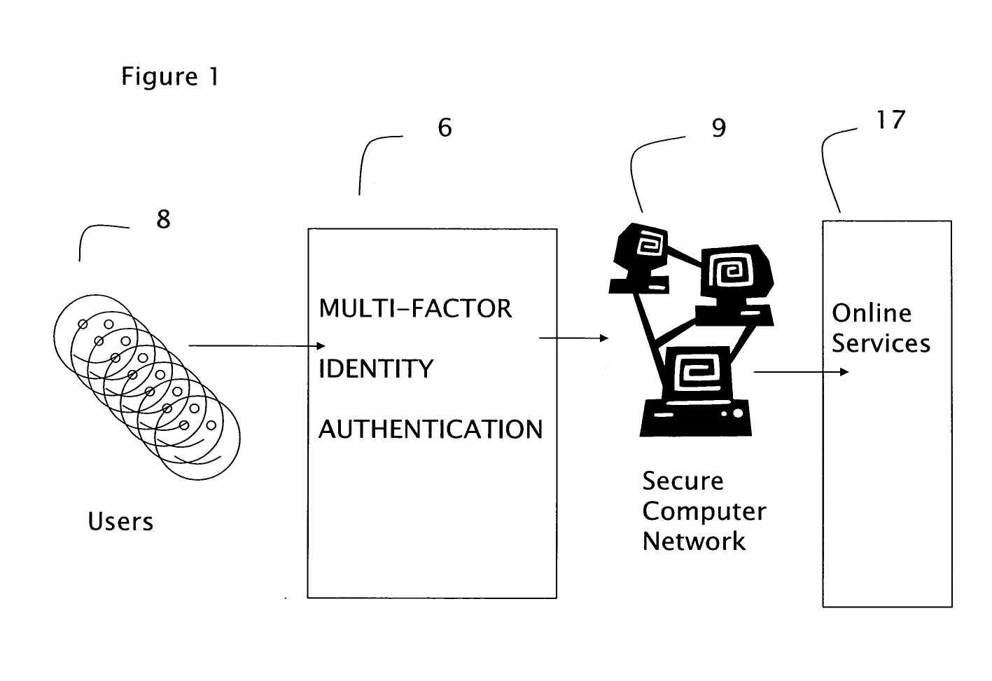

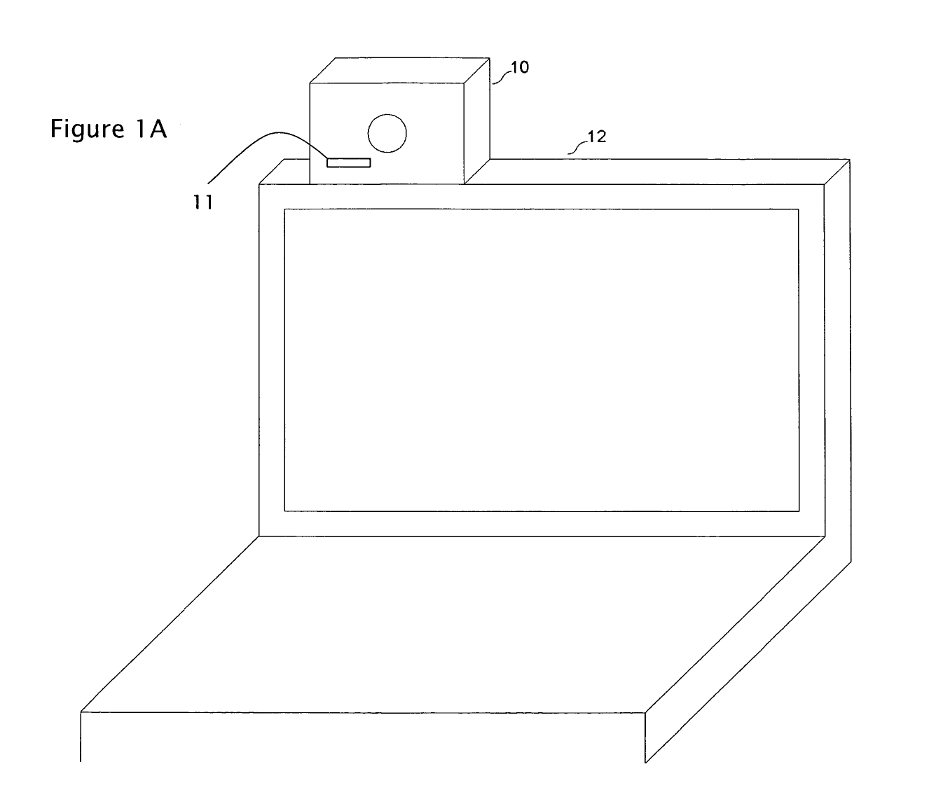

Referring to FIG. 1, my invention employs layered multi-functional identity authentication (6) to permit authorized persons (8) access a secure computer network (9) so that the users can take advantage of available on-line services (17) including the establishment of a live session of communications between a first and second individual on the network. As explained herein, the multi-factor identity authentication creates a virtual private network between two workstations located apart over a public computer network such as the Internet. By creating a digital identity for all authorized users as well as all authorized components of the system counterfeiting of system components, user identities and interception risks are minimized.

Referring to FIG. 1A, there is shown a typical installation of a biometric scanning device such as a digital video camera (10) attached to a computer (12) creating a workstation. The workstation can either be a transmitting node or a receiving node. The camera includes a card or token reading device (11) so that the camera is able to download data stored on a memory chip embedded into a card such as a “smart-card”. As shown in FIG. 1A computer is a personal notebook computer. However, the workstation may also be a desktop computer or a personal computing device such as a PalmPilot® or a mobile phone or some other analogous device. The camera would be scaled to suit the application. In another embodiment of the invention, the workstation may comprise just the camera, with processor and memory and a Voice Over Internet Protocol for a live communication session over the Internet.

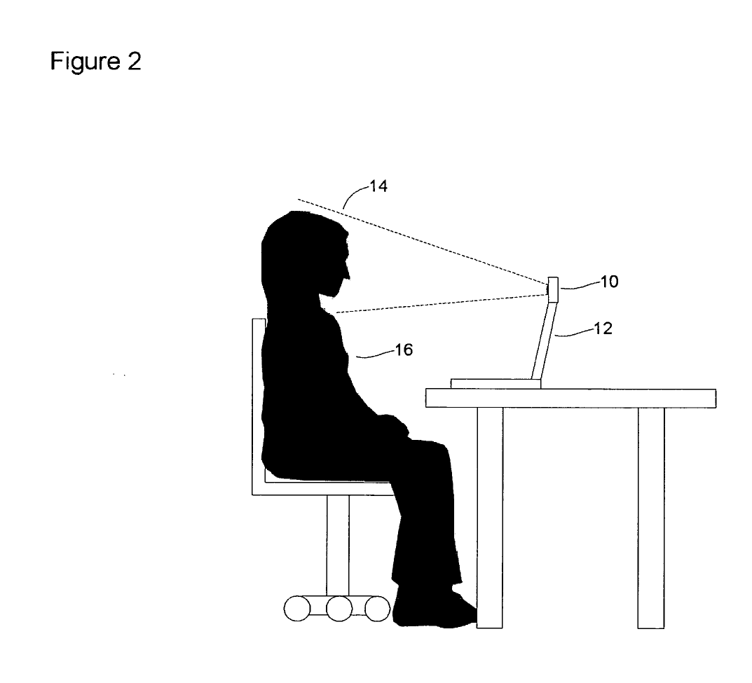

Shown in FIG. 2 is a typical installation of camera (10) mounted on computer (12) at a receiving or transmitting node. In this embodiment of the present invention, the secure access system relies upon the capture of an accurate facial image (14) of an individual seeking access to the secure system (16) to create a facial biometric for comparison to facial biometrics of authorized persons in order to create the virtual private network for communications. The camera may be affixed to the top of the computer as in the case of a notebook computer as shown in FIG. 2 or it may be affixed to some other portion of the transmitting or receiving node that affords a clear view of the individual's face. Other biometrics can be used but the preferred embodiment of the invention is the use of a facial biometric and in particular a three-dimensional facial biometric. The scanning of the facial biometric and comparison to the database of facial biometrics is but one security layer offered by the invention to create a secure virtual private network over a public computer system.

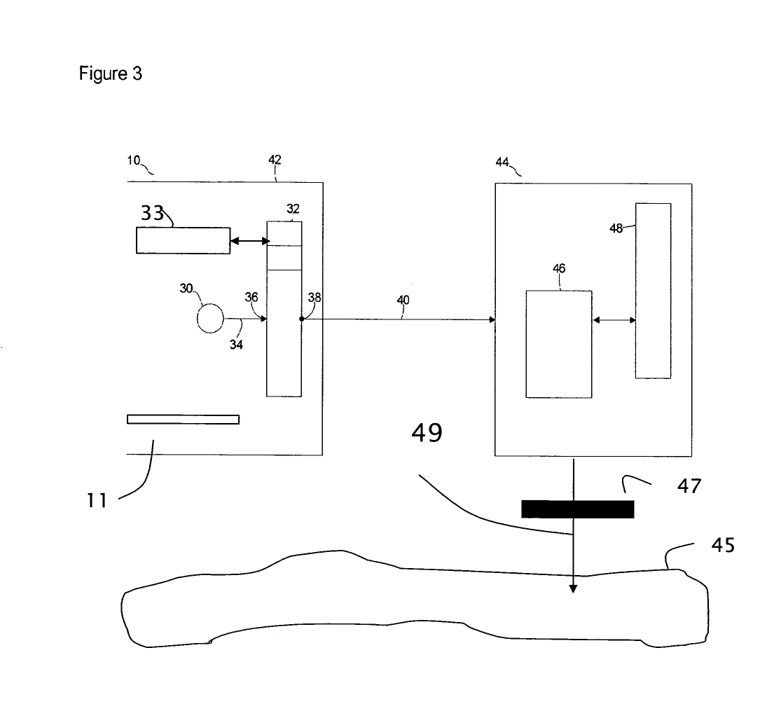

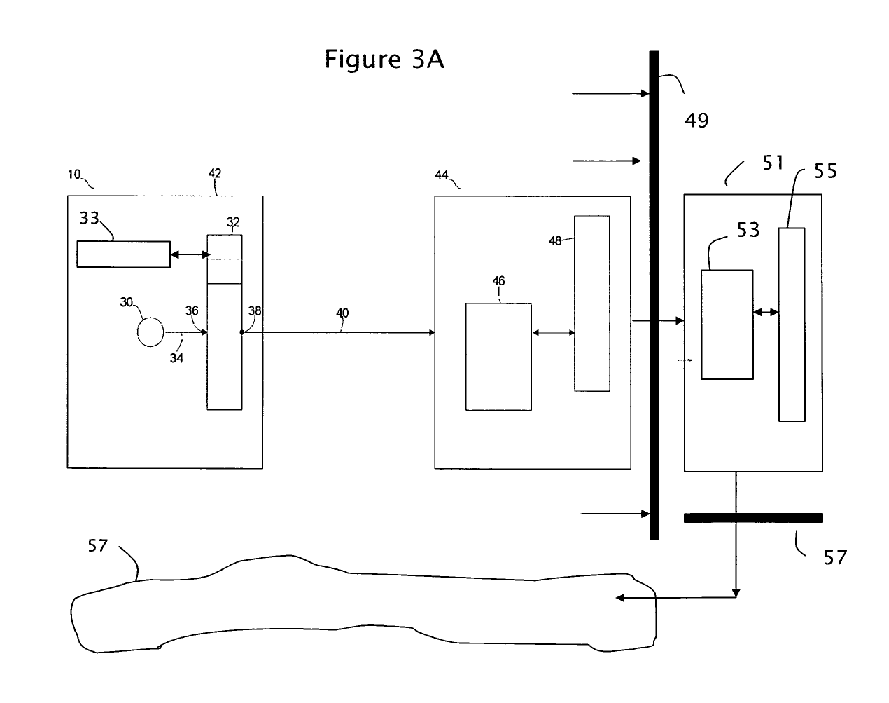

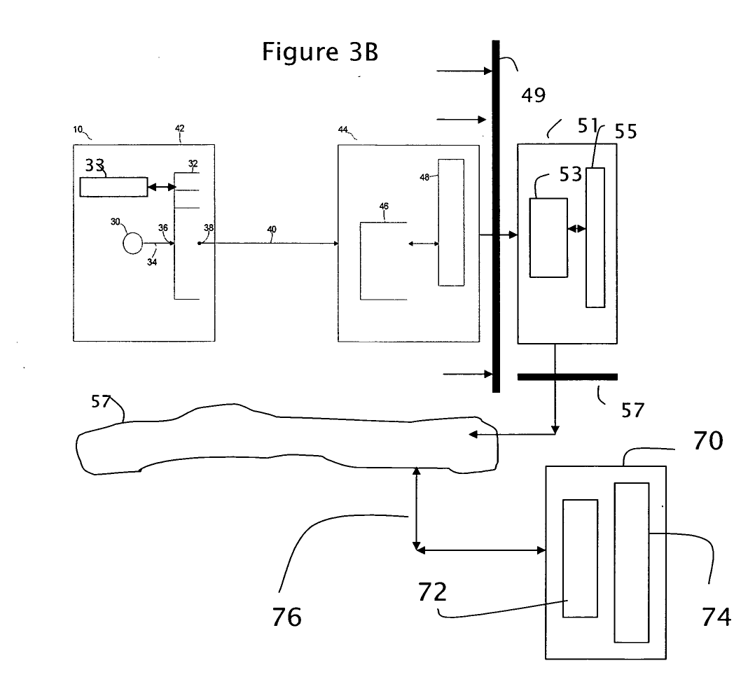

Referring to FIG. 3, there is shown a typical digital video camera (10) used for secure access applications as contemplated by the present invention. In one embodiment of the system there is a first camera at the transmitting node and a second camera at the receiving node. The first and second cameras are operatively connected to first and second computers. FIG. 3 illustrates the transmitting node but the receiving node would have identical components.

The camera can be configured to capture both two-dimensional and three-dimensional images. In the preferred embodiment of the invention three-dimensional facial imaging is used as it is more difficult to counterfeit and considerable more imaging detail of an authorized user is available. Facial imaging is also the least intrusive biometric used for secure access. The camera (10) comprises an image detector (30) that is connected to a first processor (32). Detector (30) may be a complementary metal-oxide semi conductor sensor (CMOS) having a YUV output (34). Detector (30) is connected to the processor (32) from the YUV output (34) of the detector to the left input (36) of processor (32). Processor (32) converts the digital signal received by the detector and generates a biometric template of the image. In this embodiment, the biometric template is representative of the three-dimensional facial image of the user (16). The camera also includes a first memory device (33). In one embodiment of the invention, this memory device records the PIN (Personal Identification Number) of an authorized person so that when an individual desires access to the workstation, a PIN must be entered that corresponds to the PIN stored in the camera. The system administrator may require that the PIN be used on conjunction with a smartcard or token. Alternatively, the PIN can be used by itself. A specific camera may only be authorized for a single or a limited set of users. The memory device (33) may contain a biometric of these individuals so that the camera can compare biometrics with a scanned image of the person seeking access to the workstation. Generally, the biometrics of authorized individuals will be contained on the System Guardian. The memory device (33) also contains the private key of a PKE system wherein the public key is stored on a smart-card issued to all authorized persons. The camera will be challenged to match the PIN of the individual seeking access with the PIN stored in its memory as well as matching the public and private keys in order to permit the individual access to the transmitting node. In this way the authentication of the camera is complete. Additional validation of the PIN and PKI can be done by the Network Guardian. Once the camera is authenticated the authentication of the individual seeking access can take place.

Still referring to FIG. 3, the camera is connected to a computer (44) by means of the video output bus (40). As noted previously, the camera may be integral to the computer or it may be a peripheral device. The computer (44) may be connected (49) to a computer network (45) through a firewall (47). The network (45) may be a local area network, a wide area network or a global computer network such as the Internet. The computer (44) includes a third processor (46) and a third memory device (48). The third memory device may contain all of the biometric templates of persons authorized access to the system so that when the individual seeking access is scanned by the camera the scanned biometric template is sent to the workstation processor for comparison with those templates of authorized persons stored on memory device (48). In another embodiment of the invention, the biometrics of authorized persons may be stored on a remote database securely accessible by the transmitting and receiving nodes.

FIG. 3 underscores the vulnerabilities associated with such an installation. If camera (10) were removed from the workstation (44), a counterfeit camera could be connected to the computer and unauthorized access to the network could be obtained. A further weakness relates to video signal bus (40) that could be intercepted and a counterfeit signal transmitted to the computer to gain unauthorized access to the network.

Referring now to FIG. 3A, the computer (44) is considered to be in the transmitting node. It may be only one of a network of computers connected to a bus (49) and a local server (51) that acts as the system guardian. The system guardian comprises a server processor (53) and a server memory device (55). The local server is connected through a firewall (55) to a computer network (57).

Referring now to FIG. 3B, in a preferred embodiment of the invention, there is a network guardian (70) comprising a guardian processor (72) and a guardian memory device (74). The network guardian is generally hosted by the Internet service provider. The network guardian is in communication (76) with the transmitting node server or the transmitting node computer (44) if there is no server. The role of the network guardian is to ensure that the system guardian, transmitting node network address and the receiving node network address are authentic. All authorized addresses are stored in the network guardian memory device. The network guardian will not permit a transmission from or to a node that has an address that is not authorized for the network.

In another embodiment of the invention, the system guardian includes means stored on the system guardian memory for authenticating the camera used at the transmitting and receiving nodes. This means comprises use of an electronic credential system such as a PKE system wherein the public key is stored on the camera memory device (33) and the private key stored within the memory device (74) of the system guardian. Once activated, the camera can be challenged by the system guardian to ensure authenticity. Similarly, the receiving node camera can be challenged using the same PKE system.

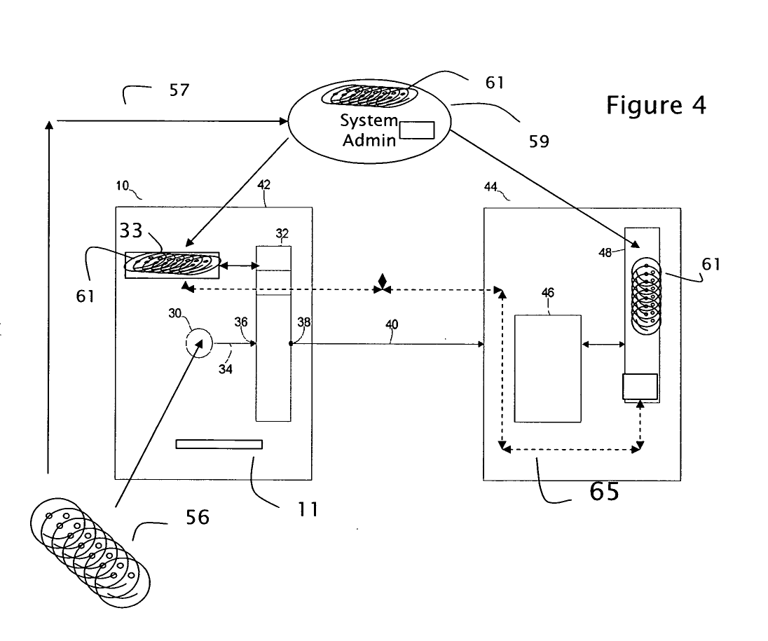

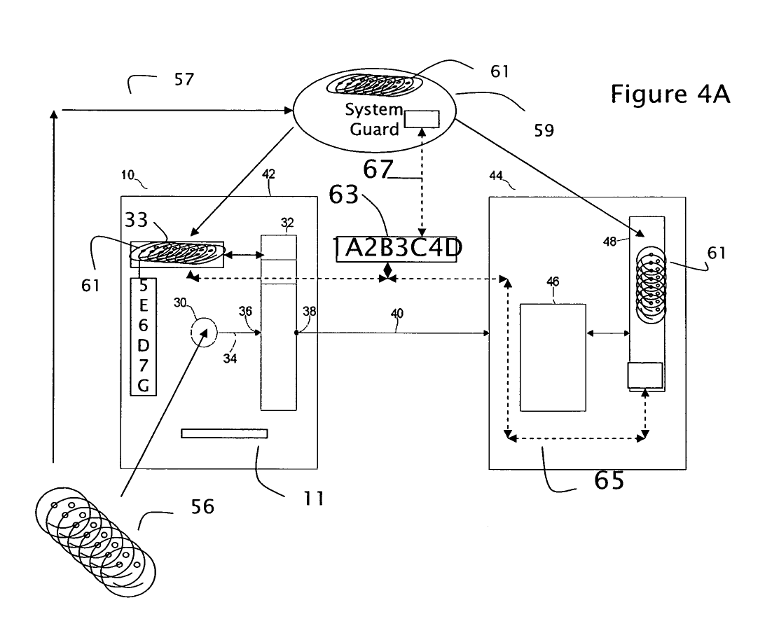

Referring now to FIG. 4 there is shown one embodiment of the present invention that enhances the creation of the VPN. FIG. 4 shows a transmitting node in detail having a camera (10) including a detector (30), a first processor (32) and a first memory device (33) housed in camera casing (42). There may be a plurality of authorized users (56) authorized to access a secure network using a single camera (10). A three-dimensional biometric template of each authorized camera user will be obtained in an enrolment process (57) by the system administrator (59) to form a set of biometric templates (61) of all authorized camera users. In one embodiment of the invention, this set may be stored in the camera first memory device (33). The first computer third memory device generally is used to store the biometrics of all persons authorized access to the network.

Referring to FIG. 4A there is shown schematically another embodiment of the invention with additional layers of security comprising a first digital alpha-numeric serial number (63) unique to the camera (10). The digital camera serial number (63) is recorded permanently into the memory device (33) during manufacture of the camera. The system guardian (59) will know the digital camera serial number and it will also be recorded into the third memory (48) of the first computer (44). When the first camera is activated, the computer (44) will query (65) the camera for its serial number and compare it to the serial number stored in the computer memory device. As well, the system guardian will query the camera (67) for its serial number. There must be a match of serial number with both the system guardian as well as the computer in order for the camera inputs to be accepted by the computer. A failure to match the serial numbers will render the camera disabled. In this way the opportunity for installing a counterfeit camera is virtually eliminated. Redundant serial codes can be used to identify the camera chassis or the CMOS (30) itself to further confirm the authenticity of the camera to the computer and the network.

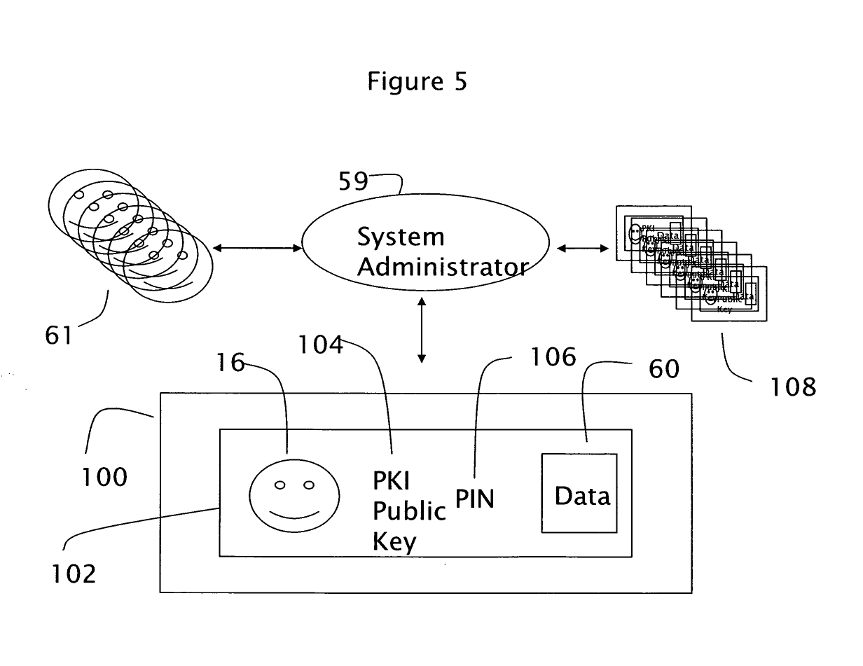

Referring to FIG. 5 the enrolment process also includes gathering personal data from each authorized person to form a data field (60). The data field may contain information relating to name, address, signature sample, position within the organization and other relevant data. The system administrator (59) collects and maintains the database and the set of biometric templates (61) obtained during enrolment. For each authorized user (16) the system administrator issues a data card or “smart-card” (100) containing a memory device (102). The smart-card will contain data to enable layered security methodology for the system such as the PIN (106) and the public key (104) for a PKE system. The card may also carry a copy of the biometric (16) of the authorized person carrying the card in an alternative embodiment.

Individual users with authorized access to the network are issued a smart-card. The smart-card will contain the PIN issued by the system administrator and the public key for the PKE system also issued by the system administrator during enrolment. When the smart-card is inserted into the card reader (11) on the camera the PIN is read and compared to the PIN on the camera memory (33). If there is a match then the camera knows that a person authorized access to the camera is attempting to use the system and the person will know that the camera is an authorized camera. Furthermore, the card reader will read the public key on the smart card and compare it to the private key on the camera memory device. If there is a match then the camera is further authenticated.

The authentication of the camera (or any other biometric scanning device) and token as a condition precedent to secure access to a remote system or user comprises the following steps:
1. A smart-card or a token is inserted into appropriate reader built into the biometric scanning device. In the illustrated example the scanning device is a camera and the reader is smart-card reader.
2. A PIN is typed by the first individual seeking secure access using the computer keyboard. The computer is connected to the camera. The system administrator can require that the PIN be used in conjunction with a smartcard or token or independently. Alternatively, an individual seeking access can speak a PIN or their name into a microphone on the biometric scanning device and speech recognition software embedded into the device or into the connected computer activates the user's PIN.

3. The system administrator can require that the smartcard or a token be used in conjunction with a PIN or independently.

4. The camera and smartcard or token perform a handshake using shared secrets or Public Key Infrastructure (PKI) and standard encryption to validate each other as being authorized hardware.

5. User information stored on the smartcard or token in conjunction with a PIN or the user's voice activates the user PIN and the biometric scanner (embedded ID), smartcard or token (shared secret, PKI and standard encryption) are validated by the Network Guardian where the appropriate information regarding biometric scanning device, smartcard, token, PIN and user's personal information are stored

Once the verification of the biometric scanning device and token are completed, verification of the individual seeking access to the system will be biometrically verified by the following steps:
1. The user seeking access to the secure system types in the address of the System Guardian to which the user is seeking remote access and where his biometric data and personal information is stored
2. The Network Guardian authenticates the System Guardian as being a valid address to which the user has been granted access
3. The System Guardian confirms the authenticity of the Network Guardian
4. The System Guardian confirms that the request from the user is valid and that the user is authorized to access the (corporations, organizations or entity's) network from a remote location.
5. The System Guardian sends to the camera or PC from where the request originated the user's biometric data and a thumbnail facial image using shared secrets, standard encryption and PKI by way of the Network Guardian.
6. The user's biometric (face, finger, iris, voice etc) or biometrics (if multi-biometrics are desired by the corporation, organization or entity, are captured by the camera and converted by the camera or PC into a biometric template
7. The user's biometric template captured by the camera is compared against the biometric template sent to the camera or PC by the System Guardian
8. If there is a match within the desired confidence level the user is authenticated and is granted remote access to the network by the System Guardian

In one embodiment of the invention just the camera is connected to the Internet. Here, the camera will obtain the biometric template of the individual seeking access to the network and compare it to a set of authorized templates stored remotely. Once the verification of the individual seeking access to the system is verified transmission from the transmitting node is permitted.

A virtual replica of each smart-card issued to each authorized individual is held by the system administrator and compiled into a database (108). This database can be stored on the transmitting and receiving node computer memories or on a remote database securely accessible by the transmitting node and receiving node computers. The smart card can be either a contact type card where the card reader (1) will read the memory device or a non-contact card wherein the reader within the card is adapted to read a radio frequency signal emitted by the card. In other embodiments combi-cards can be used where the smart card operates as a contact and non-contact card. Other biometric parameters can be used such as finger prints. The smart card may also rely upon subscriber identification module (SIM) technology in the data set (60) to hold much more than personalized authentication data. Other data contained in the data set (60) includes the name, address, position, signature facsimile of the authorized user.

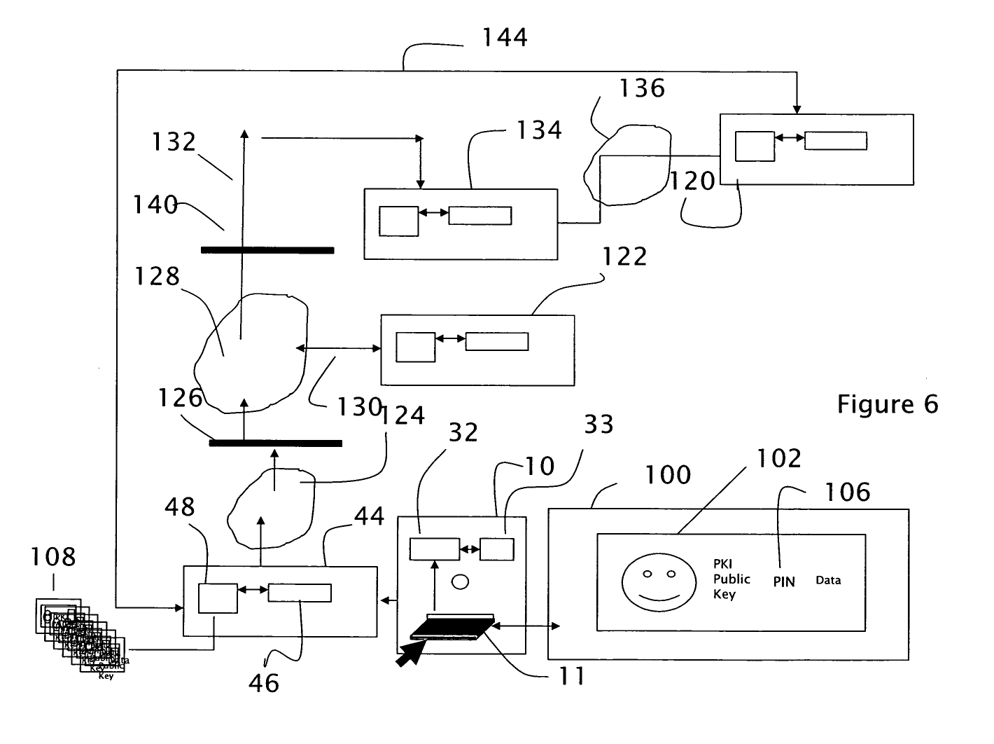

Referring now to FIG. 6, the operation of the system of the invention is explained as well as how the various layers of security can be used redundantly to create an extremely secure virtual private network over a public network of computers. Camera (10) is connected to computer (44) at the transmitting node. A first individual seeking access to the network wishes to communicate with a second individual at the receiving node computer (120) some distance away from transmitting node computer (44). The first individual has been issued with smart-card (100) having memory device (102) containing the biometric, PIN, public PKE key and other data previously described. Identical information is contained on smart cards issued to all authorized users of the network and stored as a database (108) on the computer memory (48). As well, in this embodiment, the first memory (33) of the camera contains the PIN of persons authorized access to the camera and the private key of the PKE system all stored on the smart-card (100). The individual seeking access to the network inserts the smart-card into the camera card reader (11). The reader will read the information on the smart-card and then, by way of the first processor (32) compare the information on the card with the information stored in the memory (33). The camera will be authenticated if the PIN in the camera memory matches the PIN on the smart-card and if the public key on the smart card matches the private key on the camera memory. The individual seeking access to the network may also be required to insert the PIN manually using the computer keyboard to ensure that the smart-card has not been stolen. The PIN can also be activated verbally. The PIN of the set of users permitted access to the camera is stored on the camera first storage device as well as the Network Guardian. When the PIN is properly matched, the camera knows that the individual seeking access is an authorized person.

Once the camera has been authenticated, the individual seeking access to the network is authenticated using biometrics. The camera scans the individual and obtains the desired biometric. The biometric is converted to a biometric template and then compared with the set of templates of persons authorized access to the system (108) stored on the computer memory device or remotely in some other server. If there is a match, then the camera and computer will be permitted access to the network to transmit a message to the receiving node.

The network guardian (122) will ensure that the address of the transmitting node and the address of the receiving node are authorized addresses. If a server is being used then the addresses of the servers (134) will be authenticated as well.

The message will arrive at the receiving server and then sent through the receiving local network system guardian (136) to the receiving node computer (120).

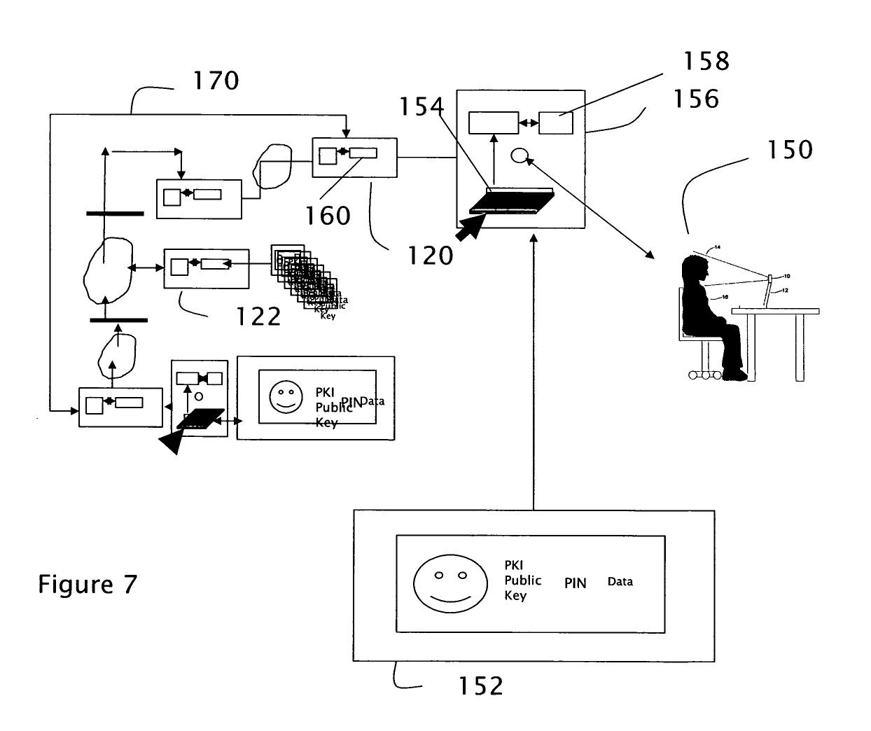

Referring now to FIG. 7, at the receiving node computer, a message received alert will announce the message. The recipient at the receiving computer will insert (120) a smart-card (152) into the card reader (154) on the camera (156). Camera validation will take place by comparisons of the PIN and PKE public key on the smart card with those stored in camera memory (158) and/or on the network guardian. Once the camera is authenticated, the identity of the recipient is authenticated biometrically. The recipient is scanned (150) to obtain a biometric for comparison with biometrics of all authorized persons stored on computer memory device (160). Once the recipient has been authenticated, the VPN is established and a live session of communications can take place.

The process for secure two-way communication is described as:
1. The camera, smartcard, token, PIN and user's computer are authenticated as described above.
2. The user's request to communicate from a remote location, or a location within the corporation, organization, or entity, with a second individual remotely located at a workstation is verified by the System Guardian and the Identity Management Software.
3. In the event the user's request is valid and access is granted by the System Guardian and Identity Management Software, a message to authenticate is sent by the System Guardian to user the second individual's camera or computer.
4. The second individual inserts a smartcard or token if one is already not in use, or types a PIN on the computer keyboard while the computer is connected to the camera.
5. The camera, the second individual's computer, smartcard, token, PIN etc (if required) are validated by the camera, System Guardian and Network Guardian as previously discussed.
6. The second individual is authenticated biometrically as described above.
7. The System Guardian communicates via the Network Guardian with the originating user's camera (i.e. the user who requested the communication) and a VPN is setup between the requesting user and second individual.
8. The requesting user's computer may be in a remote location or be located on the corporation, organizations or entity's LAN.
9. Communications refers to voice, streaming video, text, emails and instant messages either as part or an integrated application or individually

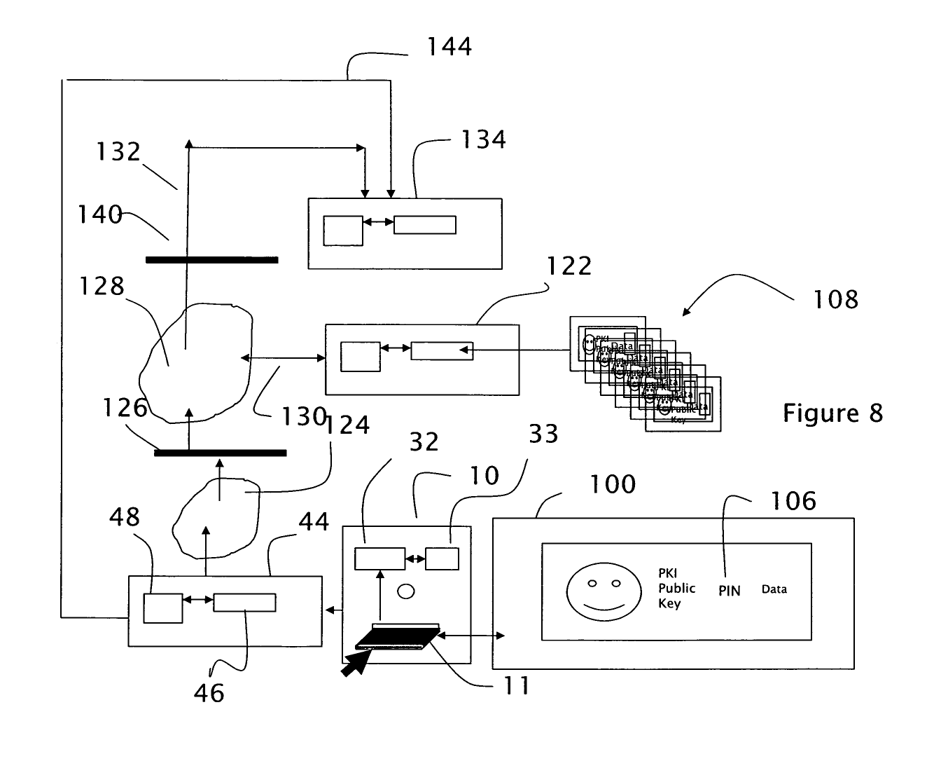

Referring now to FIG. 8, the invention can be used to access remote records stored in an access controlled area such as an off-site electronic record repository. In the schematic drawing of FIG. 8, the remote electronic data repository is shown as workstation (134) although it could be a network of storage devices. In order to access the data repository, the user must first insert the smart-card (100) into the card reader (11) on the camera (10). The validity of the smart-card is verified as previously described. The camera then scans the user seeking access and converts the scan into a biometric template of the user's face. The template is compared to the collection of biometric templates of authorizes users at the system guardian (122). Once the user is authorized then the user will permitted to pass the firewall (140) and access the electronic record repository (134). In effect, a VPN (144) has been established between the user workstation (44) and the target data repository (134).

In the event that the transmitting node desires access to secure data rather than an individual, the following process is followed:
1. The camera, smartcard, token, PIN and user's computer are authenticated as described in items (1) and (2).
2. The user's request to access secure data from a remote location is verified by the System Guardian against the (corporation's, organization's or entity's) user's access rights stored in the Identity Management Software or other such similar application.
3. In the event access to the secure data is granted by the Identity Management software, the user is connected by the System Guardian and Identity Management software by way of a VPN to the server where the data is stored and to the secure data.
4. VPN clients are embedded in the camera and requesting computer as well as the workstation/server where the secure data is stored.
5. Standard VPN servers are embedded in the Network Guardian and System Guardian

In yet another embodiment of the invention, all communications over the network are encrypted using SSL.

Voice over Internet Protocol may also be used during the live session between the receiving node and the transmitting node.

In another embodiment of the invention, the user computer (44) and camera (10) may be located remotely and connected to the computer network by wireless means. Smart-card verification and biometric verification of the user seeking access can still be accomplished by transmitting the required data over a wireless link to the system guardian.

Numerous modifications, variations, and adaptations may be made to the particular embodiments of the invention described above without departing from the scope of the invention that is defined in the claims.

What is claimed is:

1. A system and method for creating a virtual private network (VPN) over a computer network using multi-layered permissions-based access control, said system comprising:
a. a first individual seeking to send a live message from a transmitting node to a second individual at a receiving node over a computer network;
b. means for identifying persons authorized access to said computer network;
c. a network guardian for authenticating the identity of said transmitting and receiving nodes;
d. a system guardian for authenticating the identity of said first and second individuals as persons authorized access to the computer network.

2. The system of claim 1 wherein said means comprises a system administrator for enrolling persons authorized access to the computer network by obtaining a personal data set form each person.

3. The system of claim 2 wherein said personal data set comprises at least one biometric identification means.

4. The system of claim 3 wherein said at least one biometric identification means comprises a facial biometric of each person.

5. The system of claim 4 wherein said facial biometric is a three-dimensional facial biometric of each person.

6. The system of claim 5 wherein said transmitting node comprises a first camera having a first processor and first memory means operatively connected to a first computer having a second processor and second memory means.

7. The system of claim 6 wherein said receiving node comprises a second camera having a third processor and third memory means operatively connected to a second computer having a fourth processor and fourth memory means.

8. The system of claim 7 wherein said network guardian comprises
(a) first and second camera authentication means; and, (b) first and second workstation authentication means.

9. The system of claim 8 wherein first and second camera authentication means comprises a personal identification number issued to each person and stored on the first and second camera first and third memory means respectively and on the network guardian.

10. The system of claim 9 wherein first and second camera authentication means further comprises PKE means whereby a public key is issued to each person by the system administrator and stored on a smart-card issued to each person and a private key is stored on the first and third memory means of the first and second cameras and on the network guardian.

11. The system of claim 10 wherein camera authentication comprises (a) matching the personal identification number issued to each person to the personal identification number stored on the first and third memory means and the network guardian; and (b) matching the public key issued to each person to the private key stored on the first and third memory means of the first and second cameras and the network guardian.

12. The system of claim 11 wherein the transmitting node and receiving node authentication means comprises a first and second address unique to the transmitting node and receiving node respectively wherein said first and second addresses are known to the network guardian and confirmed the network guardian as addresses authorized by the system.

13. The system of claim 12 wherein the system guardian compares the biometric of said first and second individual against the biometrics of all persons authorized access to the network.

14. The system of claim 13 wherein said VPN is established upon authentication of the first and second individuals as authorized persons by the system guardian.

15. The system of claim 14 wherein said live message is encrypted.

16. The system of claim 15 wherein the live message is encrypted using secure sockets layering.

17. The system of claim 16 wherein the live message is by way of VOIP (Voice Over Internet Protocol).

18. A system and method for creating a virtual private network (VPN) over a computer network using multi-layered permissions-based access control, said method comprising the steps of:
a. providing a first individual seeking to send a live message from a transmitting node to a second individual at a receiving node;
b. providing means for identifying persons authorized access to said system;
c. providing a network guardian for authenticating the identity of said transmitting and receiving nodes; and,
d. providing a system guardian for authenticating the identity of said first and second individuals as persons authorized access to the system.

19. The method of claim 18 further including the step of providing a system administrator to enrol said persons authorized access to the system by obtaining a personal data set from each person, said personal data set comprising at least one biometric identification means.

20. The method of claim 19 wherein the authentication of the biometric scanning device comprise the following steps:
a. inserting a smart-card or a token is inserted into an appropriate reader built into the biometric scanning device;
b. inputting a PIN;
c. comparing said PIN with a PIN stored on the biometric scanning device;
d. comparing said PIN with a PIN stored on a network guardian;
e. inputting a public key;
f. comparing said public key with a private key stored on the biometric scanning device;
g. comparing said public key with a private key stored on the network guardian;
h. verifying that the public key matches the private key;
i. verifying that the inputted PIN matches the stored PIN.

21. The method of claim 20 further comprising steps to biometrically verify the authenticity of said first and second individuals, said steps comprising:
a. inputting the address of a recipient system guardian;
b. authenticating the identity of said recipient system guardian;
c. authenticating the identity of the network guardian;
d. authenticating the identity of the first and second individuals by;
e. sending an encrypted first and second individual biometric stored in the system guardian to a biometric scanning device in communication with the system guardian;
f. decrypting said biometric;
g. scanning the same biometric of the first and second user;
h. comparing the scanned biometric with the stored biometric;
i. allowing access to the system if there is match within a predetermined confidence interval.
